(19) United States
(12) Patent Application Publication
(10) Pub. No.: US 2023/0222296 A1
(43) Pub. Date: Jul. 13, 2023

(54) Arabic Latinized

(71) Applicant: Rassan Mohammad Tarabein, Fairhope, AL (US)

(72) Inventor: Rassan Mohammad Tarabein, Fairhope, AL (US)

(21) Appl. No.: 17/572,975

(22) Filed: Jan. 11, 2022

(51) Int. Cl. G06F 40/53; G06F 40/129

(52) U.S. Cl. CPC G06F 40/53; G06F 40/129

(57) ABSTRACT

Arabic Latinized is the first and only technique to learn Arabic Language that is based on conditioning the mind to convert Arabic to Latin, in reading and writing.

The Arabic alphabet: Consists of 28 letters and 1 auxiliary called Hamza (table in FIGS. 1 and 2).

“Arabic letters in common”; Nineteen, are pronounced as in Latin.

“Arabic letters in proper”: Nine, plus the auxiliary Hamza (10 letters), also called “Gluttural Letters”, they exist only in Arabic.

The correct way of pronouncing the Arabic “guttural Letters” with the anatomical site to produce those letters is illustrated in FIG. 3

“Hamza”, the 29^{th} auxiliary Letter is pronounced a “guttural catch or pause” in the voice, as the letter “A” in “Apple” sounds; FIG. 3. It can be independent stand-alone “ [symbol] ”, or add-on to any of the Vowel letters:
Alef (#1), either above, written as “ [symbol] ”
   or beneath, written as “ [symbol] ”
Waw (#27), only above, written as “ [symbol] ”
Ya' (#28), only above, written as “ [symbol] ”

The technique of Arabic letters' conversion to Latin is illustrated in FIGS. 4 and 5.

The invention attended to every detail unique to the Arabic language, especially the symbols of Short Vowels (FIG. 6)

### BACKGROUND OF THE INVENTION

Arabic Latinized is the first and only technique that helps Latin-speaking people learn Arabic the fastest possible way.

### BRIEF SUMMARY OF THE INVENTION

It is build upon programming the mind to pair Arabic with Latin letters and read Latin as in Arabic, from right to left (FIG. 4), making it easier to brigde Arabic over to Latin.

### CROSS-REFERENCE TO RELATED APPLICATIONS

None, as Arabic Latinized, is the first and only invention of Dr. Tarabein (the inventor).

### BRIEF DESCRIPTION OF THE DRAWINGS

FIG. 1 is a table that shows the first 16 (of 28) Arabic characters, compared to English.

FIG. 2 is a table that shows the last 12 (of 28) Arabic characters compared to English.

FIG. 3 is a schematic illustration of the anatomical sites that helps learners correctly to pronounce the ten Arabic “Gutteral Letters”, which are unique only to the Arabic language.

FIG. 4 is an example that demonstrates the methodology of substituting and aligning Latin letters.

FIG. 5 is another practical example of replacing and aligning Latin letters.

FIG. 6 illustrates how Arabic Latinized is construed to be parallel to Latin.

### DETAILED DESCRIPTION OF THE INVENTION

### The Technique

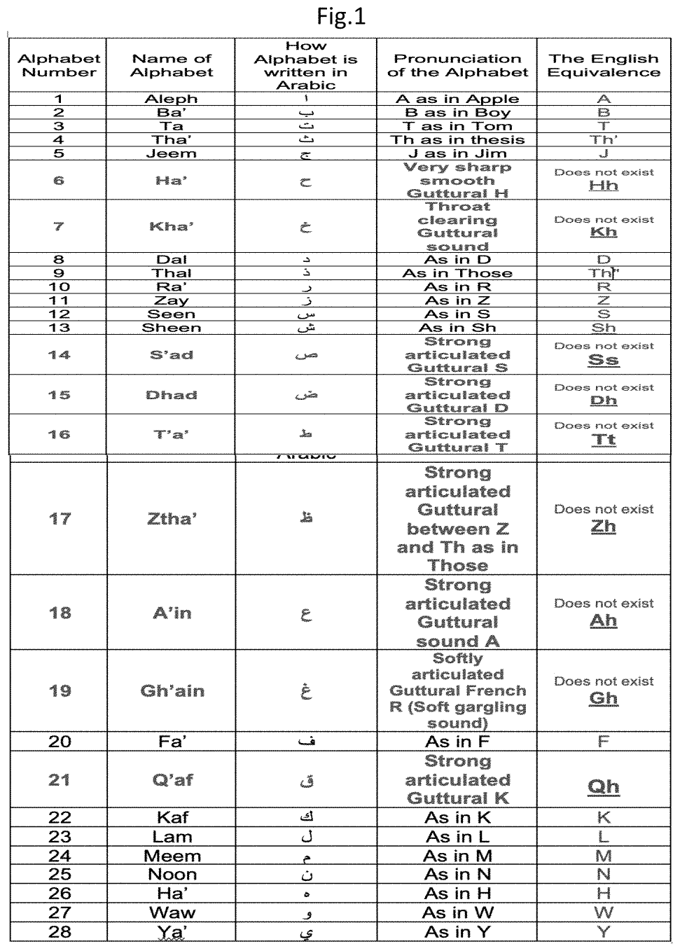

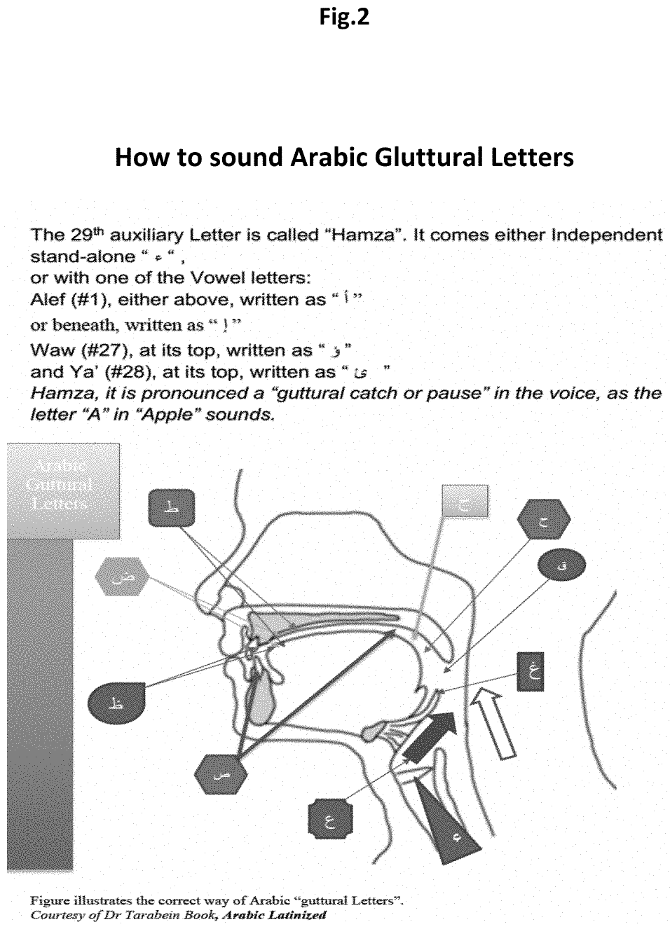

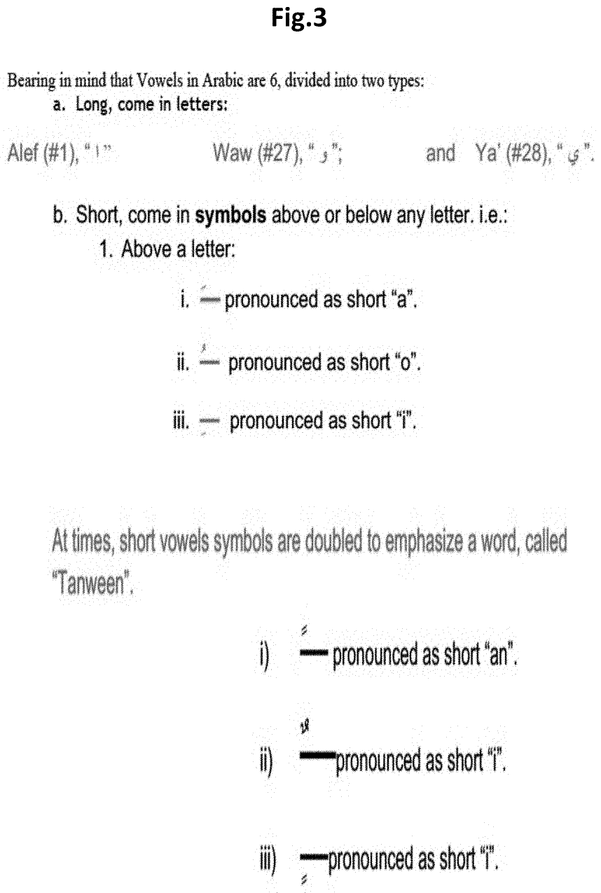

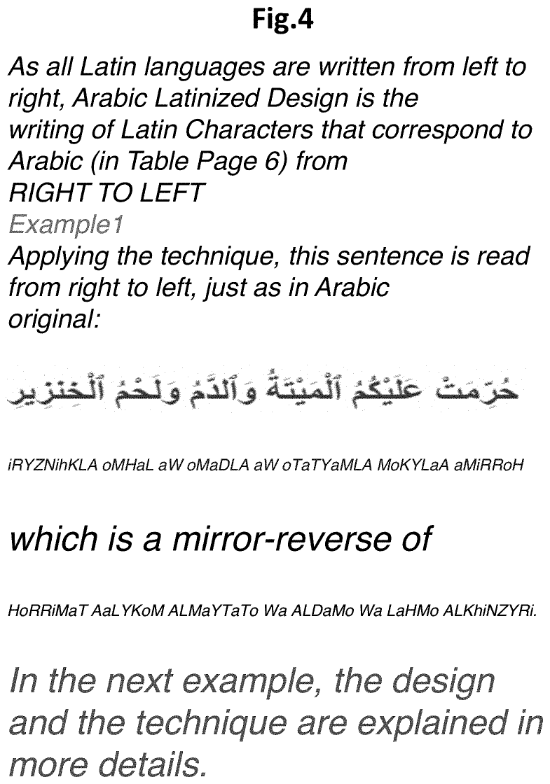

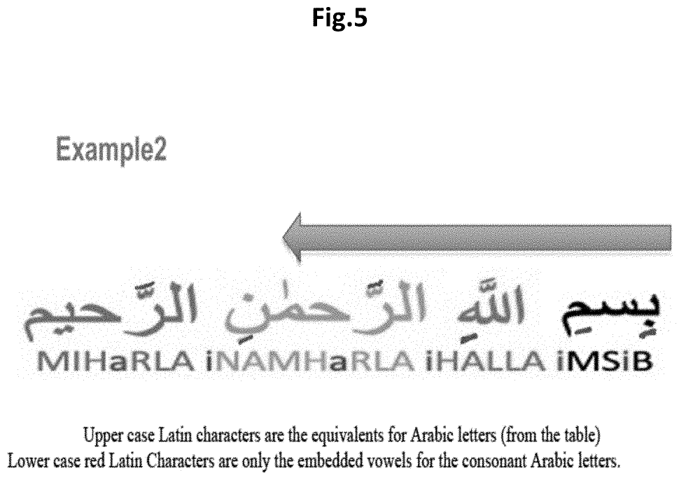

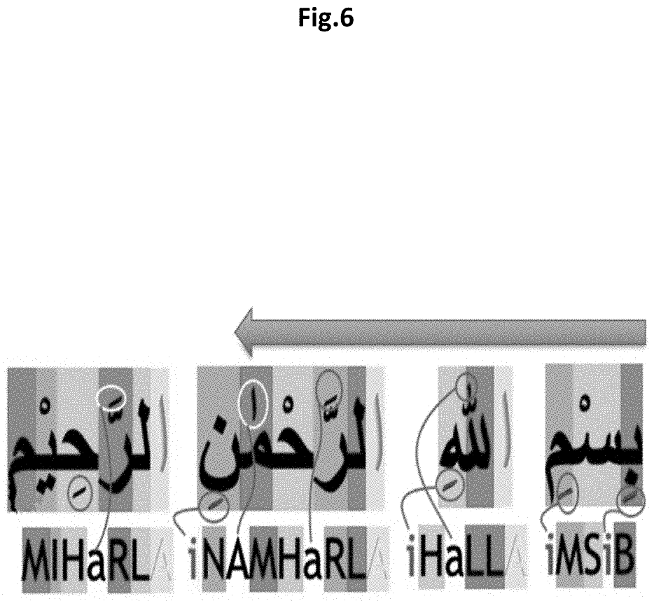

There are 28 letters in Arabic (FIGS. 1 and 2). Nineteen letters exist in Latin and are pronounced the same, so I call them “Arabic letters, Common”. The remaining nine letters (besides an auxiliary letter, called “Hamza”) are unique and exist only in Arabic. That's why I call those “Arabic Letters, Special” (FIG. 3). As explained in the two illustrative examples given in (FIGS. 4 and 5), showing the technique. Making Arabic analogous to Latin helps to learn Arabic effortlessly. (FIG. 6) explains the methodology of substituting Arabic with Latin letters but aligning them to be read in the same manner as Arabic, from right to left.

The applicant, Rassan M Tarabein, claims Arabic Latinized from its title to the concept, and the technique as his intellectual property to be protected.

1. The claim specifically includes:
1) Arabic characters convergence to Latin Characters, as outlined in the table in FIG. 1 and FIG. 2.
2) The Latin Characters are aligned to be read from right to left, in unity with the direction of reading Arabic, FIG. 6 and FIG. 4
3) Arabic letters are represented with upper case Latin letters, FIG. 3 and The Arabic symbols of Short Vowels are represented in lower case Latin letters, FIG. 5
